(19) United States
(12) Patent Application Publication
(10) Pub. No.: US 2004/0039638 A1
(43) Pub. Date: Feb. 26, 2004

(54) Service charge reducing method and system for portable terminal, and program recording medium

(75) Inventor: Takashi Moriyama, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/642,192

(22) Filed: Aug. 18, 2003

(30) Foreign Application Priority Data
Aug. 21, 2002 (JP) 240033/2002

(51) Int. Cl. G06F 17/60

(52) U.S. Cl. 705/14

(57) ABSTRACT

The present invention provides a method for reducing a service charge of a portable terminal in which the portable telephone user can set the extraction condition of the advertising information and the feedback information from the portable telephone can be returned.

A resident application is transmitted to the portable telephone by transmitting the necessary information from a site perusal function of the portable telephone to an advertising information administration center. A CPU sets up the extraction condition of the advertising information in accordance with the resident application, and initiates the site perusal function when the advertising information is displayed. Thereby, the portable telephone user does not receive unnecessary advertising information and can be linked with the existing service provider for the Internet shopping, and so forth.

### BACKGROUND OF THE INVENTION

1. Field of the Invention

The present invention relates to a method for reducing a service charge of a portable terminal and a system therefor and a recording medium having a program recorded thereon, and more particularly to a method for reducing a service charge of a portable telephone and its system and a recording medium having a program recorded thereon.

2. Description of the Prior Art

One example of the conventional charging system and method for the mobile terminal equipment is described in Japanese Patent Laid-Open No. 2001-309087. This technique as described in the publication involves reducing a service charge for a portable telephone in such a way that if an advertising transmission server transmits a predetermined number of advertisement mails to the portable telephone of a member stored in a data holding part, a charging server reduces the service charge for the portable telephone of the member in accordance with the number of advertisement mails that the advertisement transmission server has transmitted to the member.

However, this conventional technique had the following problems. A first problem is that the advertising information unnecessary for the portable telephone user is transmitted. Its reason is that the extracting condition is not set by the portable telephone user, and the advertising information is distributed for the convenience of an advertising information administration center.

A second problem is that it is unknown whether or not the portable telephone user has seen the advertising information. Its reason is that the information is distributed in one way from the advertising information administration center to the portable telephone using the mail without feeding back information from the portable telephone.

### BRIEF SUMMARY OF THE INVENTION

Thus, it is an object of the present invention to provide a method and system for reducing a service charge of a portable terminal, and a program therefor in which the extracting condition of the advertising information is set by the portable telephone user and the feedback information is transmitted from the portable telephone.

According to the invention, there is provided a service charge reducing method for a portable terminal to reduce a service charge of the portable terminal, in which the portable terminal and an advertising information administration center are connected via a network and the portable terminal receives a distribution of the predetermined advertising information from the advertising information administration center, the method comprising a program transmission step of transmitting a program for reducing the service charge of the portable terminal from the advertising information administration center to the portable terminal in response to a request from the portable terminal, and a service charge reducing step of performing a service charge reducing process for the portable terminal including setting the extracting condition of the advertising information in accordance with the program at the portable terminal.

Also, according to the invention, there is provided a service charge reducing system for a portable terminal to reduce a service charge of the portable terminal, in which the portable terminal and an advertising information administration center are connected via a network, and the portable terminal receives a distribution of the predetermined advertising information from the advertising information administration center, the system comprising program transmission means for transmitting a program for reducing the service charge of the portable terminal from the advertising information administration center to the portable terminal in response to a request from the portable terminal, and service charge reducing means for performing a service charge reducing process of the portable terminal including setting the extracting condition of the advertising information in accordance with the program at the portable terminal.

Also, according to the invention, there is provided a recording medium having recorded thereon a program for causing a computer to perform a service charge reducing process for a portable terminal, in which the portable terminal and an advertising information administration center are connected via a network, and the portable terminal receives a distribution of the predetermined advertising information from the advertising information administration center, wherein in the case of transmitting a program for reducing the service charge of the portable terminal from the advertising information administration center to the portable terminal in response to a request from the portable terminal, the program comprises a step of performing the service charge reducing process of the portable terminal including setting the extracting condition of the advertising information in accordance with the program at the portable terminal.

That is, according to the invention, the extraction condition of advertising information can be set by the portable telephone user, and the feedback information can be transmitted from the portable telephone.

With the invention, the advertising information can be acquired, saved and presented, employing a resident application operating on the portable telephone and capable of being downloaded, whereby the service charge of the portable telephone for the portable telephone user is reduced in accordance with the acquisition number and presentation number of the advertising information that are administered in that application.

Also, with the invention, the portable telephone user sets the extraction condition of the advertising information, employing the application, whereby the portable telephone user does no acquire the unnecessary advertising information.

Also, with the invention, the application and the site perusal function are linked with the existing service provider for the Internet shopping to achieve the effective sales.

### BRIEF DESCRIPTION OF THE DRAWINGS

FIG. 1 is a block diagram of a service charge reducing system for a portable terminal according to the best embodiment of the present invention;

FIG. 2 is a flowchart showing a process of registering the user information;

FIG. 3 is a flowchart showing a process of distributing the advertising information;

FIG. 4 is a flowchart showing a process of presenting the advertising information;

FIG. 5 is a flowchart showing a process of transmitting the presentation number information; and

FIG. 6 is a flowchart showing a process of reducing the service charge.

### DETAILED DESCRIPTION OF THE PREFERRED EMBODIMENTS

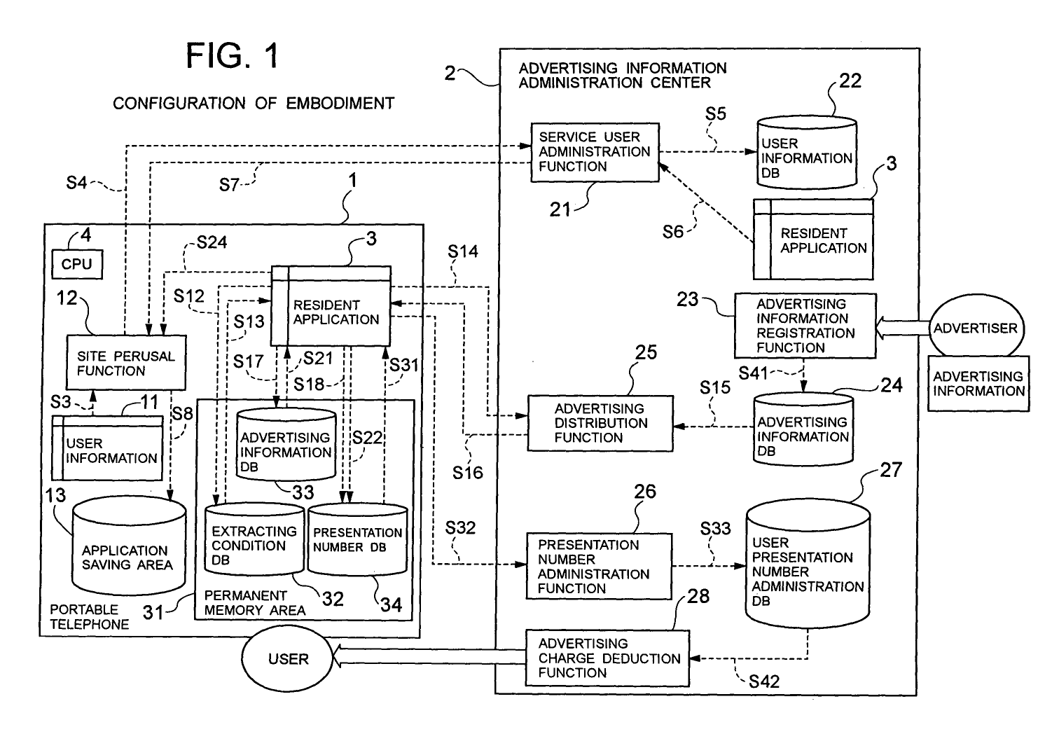

The preferred embodiments of the present invention will be described below with reference to the accompanying drawings. FIG. 1 is a block diagram of a service charge reducing system for portable terminal according to the best embodiment of the present invention. As will be seen from FIG. 1, the service charge reducing system for portable terminal comprises a portable telephone 1 and an advertising information administration center 2.

Also, the portable telephone 1 and the advertising information administration center 2 are connected via a network (communication network). More specifically, as one example, the portable telephone 1 is connected to the advertising information administration center 2 via the network such as a portable telephone packet network, a portable telephone network server, or the Internet.

The portable telephone 1 comprises the user information 11 that is the information proper to the portable telephone and possessed by the portable telephone, a site perusal function 12 for perusing a Web site publicized for the portable telephone, a download application saving area 13 (area for saving a resident application 3) for saving an application for portable telephone that is publicized at the Web site and can be downloaded into the portable telephone, a permanent memory area 31 usable from the downloaded application, an extracting condition database (hereinafter referred to as DB) 32 for use with the resident application 3, an advertising information DB 33, a presentation number DB 34, a resident application 3 that is downloaded from the advertising information administration center 2, and a central processing unit (hereinafter referred to as a CPU) 4 for executing a predetermined processing in accordance with the resident application 3.

The advertising information administration center 2 comprises a service user administration function 21 (Web site) of saving the user information of the portable telephone user who receives a service of the invention and distributing an application to the portable telephone, a user information DB 22 for saving the user information 11 transmitted from the portable telephone 1, a resident application 3 operating on the portable telephone side for communicating with the advertising information administration center 2 to receive the advertising information, and administer and transmit the presentation number, an advertising information registration function 23 of processing the advertising information from an advertiser into the information directed for the portable telephone, an advertising information DB 24 for saving the information processed by the advertising information registration function 23, an advertising distribution function 25 of extracting the advertising information necessary for an advertising information acquisition request transmitted periodically from the portable telephone from the advertising information DB 24 and distributing it to the portable telephone, a presentation number administration function 26 of holding the presentation number or the acquisition number of advertising information on the portable telephone side transmitted periodically from the portable telephone on the center side, a user presentation number administration DB 27 for saving the presentation number for each user processed by the presentation number administration function 26, and an advertisement listing charge deduction function 28 of deducting an advertisement listing charge to reduce the service charge for the portable telephone periodically on the basis of the information of the user presentation number administration DB 27.

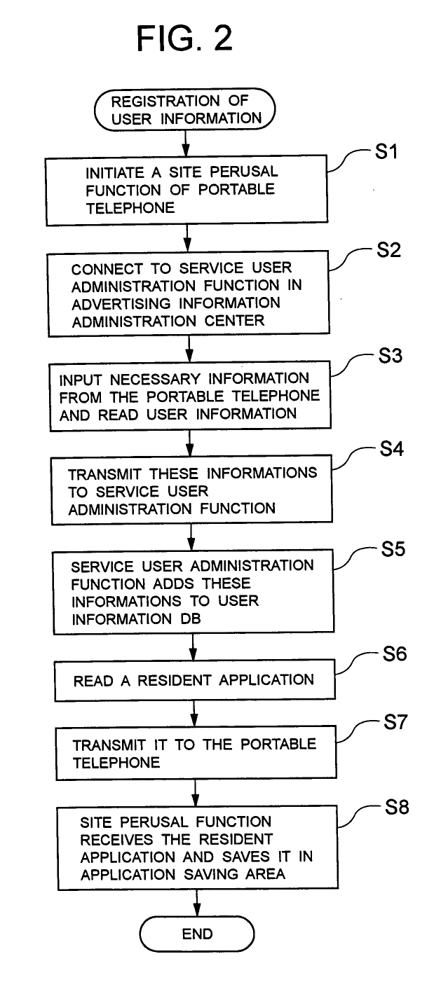

This embodiment will be described by way of example. Firstly, a first example will be described below. The first example concerns the registration of the user information. FIG. 2 is a flowchart showing a process for registering the user information. Referring to FIGS. 1 and 2, the portable telephone user initiates the site perusal function 12 (S1), and connects it to the service user administration function 21 of the advertising information administration center 2 to make the service user registration (S2).

The portable telephone user inputs the necessary information on the screen that the site perusal function 12 displays, and reads the portable telephone information (hereinafter referred to as the user information) 11 proper to the portable telephone and possessed within the portable telephone (S3), and transmits these informations to the service user administration function 21 (S4).

The service user administration function 21 receives the user information 11, and adds this information to the user information DB 22 within the advertising information administration center 2 (S5). If addition is normally completed, the service user administration function 21 reads the resident application 3 operating on the portable telephone (S6), and transmits it to the portable telephone 1 (S7).

The site perusal function 12 receives the resident application 3, and saves it in the application saving area 13 of the portable telephone 1 (S8).

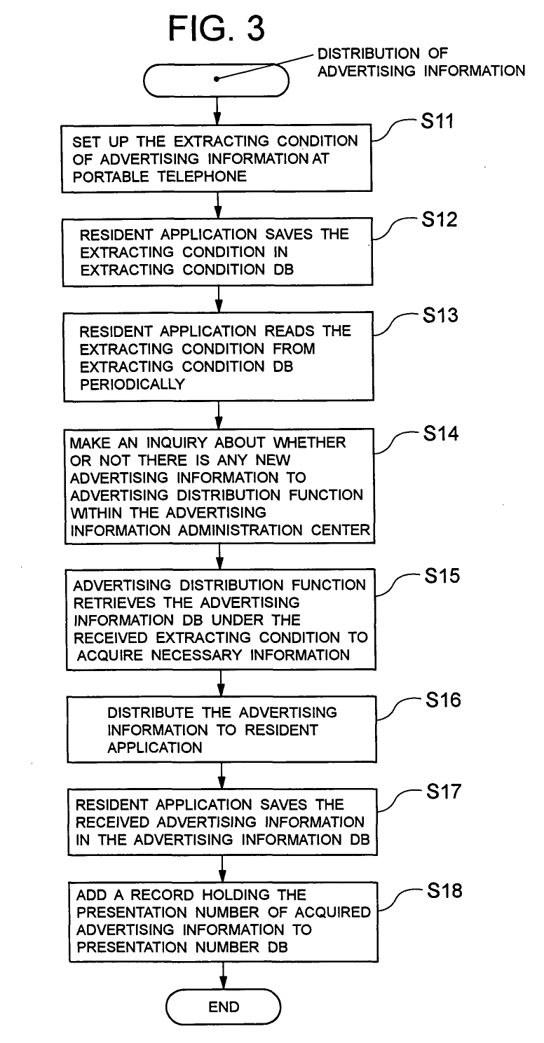

A second example will be described below. The second example concerns the distribution of the advertising information to the portable user. FIG. 3 is a flowchart showing a process for distributing the advertising information. Referring to FIGS. 1 and 3, the resident application 3 (or particularly the CPU4 in accordance with the resident application 3) prompts the portable telephone user to set up the extracting condition on a display screen at the first initiation. If the portable telephone user sets up the extracting condition of the advertising information (S11), the resident application 3 saves this extracting condition in the extracting condition DB 32 kept within the permanent memory area 31 of the portable telephone (S12). The settings of the extracting condition refer to the settings of only the advertising information required by the portable telephone user. The portable telephone user initiates the resident application 3 with the extracting condition set up at any time to receive this service.

The resident application 3 reads the extracting condition from the extracting condition DB 32 periodically (e.g., every week or everyday) (S13), and makes an inquiry of whether or not there is any new advertising information to the advertising distribution function 25 within the advertising information administration center 2 (S14).

The advertising distribution function 25 retrieves the advertising information DB 24 under the extracting condition received from the portable telephone 1 to acquire the necessary advertising information (S15). And after acquiring the advertising information, the advertising distribution function 25 distributes the advertising information to the resident application 3 that has been initiated at the portable telephone 1 (S16).

The resident application 3 of the portable telephone 1 receives the advertising information, and saves it in the advertising information DB 33 (S17). Also, a record holding the presentation number of the acquired advertising information is added to the presentation number DB 34 (S18).

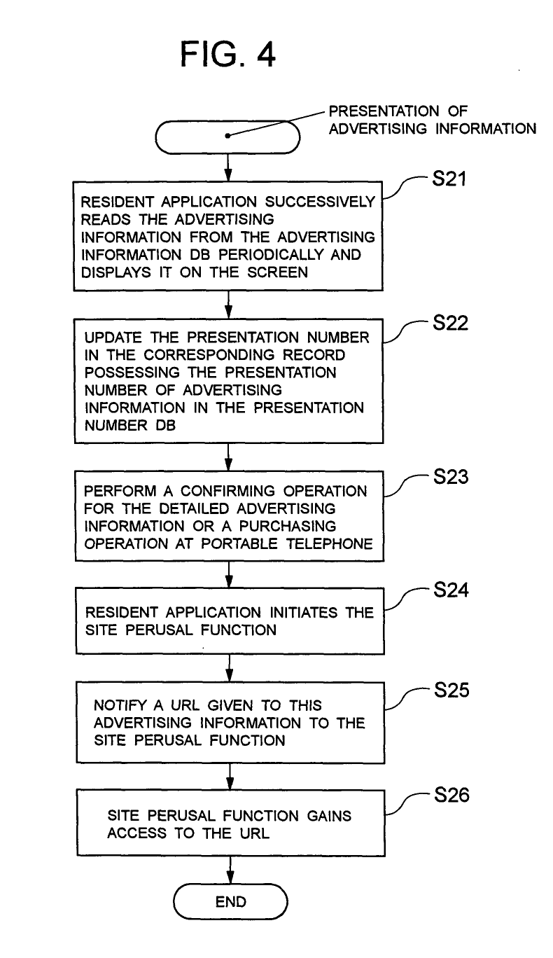

A third example will be described below. The third example concerns the presentation of the advertising information saved at the portable telephone. FIG. 4 is a flowchart showing a process for presenting the advertising information. Referring to FIGS. 1 and 4, the resident application 3 reads successively the advertising information stored in the advertising information DB 33 periodically (e.g., every hour or every six hours) and displays it on the screen of the portable telephone (S21). Also, the resident application 3 updates the presentation number of the corresponding record in the presentation number DB 34 holding the presentation number of the advertising information, when the display on the screen is completed (S22).

The portable telephone user makes a confirming operation of the detailed advertising information or a purchasing operation while the resident application 3 displays the advertising information (S23). Then, the resident application 3 initiates the site perusal function 12 (S24), and notifies the URL (Uniform Resource Locator) given to the advertising information to the site perusal function 12 (S25). That is, the resident application 3 invites the portable telephone user to a commodity introduction site or a purchase site. The portable telephone user gains access to the URL from the site perusal function 12 (S26).

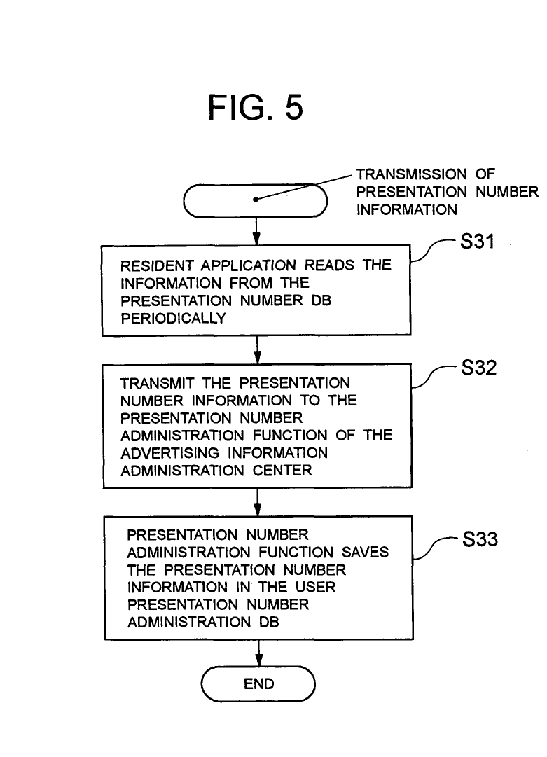

A fourth example will be described below. The fourth example concerns the transmission of the presentation number information held at the portable telephone to the advertising information administration center 2. FIG. 5 is a flowchart showing a process for transmitting the presentation number information. Referring to FIGS. 1 and 5, the resident application 3 reads the information in the presentation number DB 34 periodically (e.g., every month) (S31), and transmits it to the presentation number administration function 26 in the advertising information administration center 2 (S32).

The presentation number administration function 26 in the advertising information administration center 2 receives the presentation number information from the portable telephone, and saves it in the user presentation number administration DB 27 (S33).

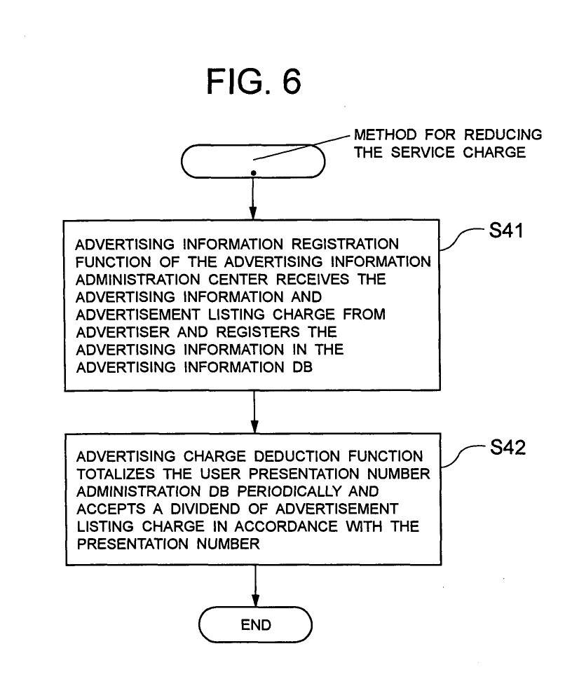

A fifth example will be described below. The fifth example concerns the method for reducing the service charge to the portable telephone user. FIG. 6 is a flowchart showing a process for reducing the service charge. Referring to FIGS. 1 and 6, the advertising information registration function 23 within the advertising information administration center 2 receives the advertising information (introducing information of commodity or service and information such as the URL to the existing site) and the advertisement listing charge from the advertiser and registers the advertising information in the advertising information DB 24 (S41).

The advertising charge deduction function 28 within the advertising information administration center 2 totalizes the information of the user presentation number administration DB 27 periodically, and accepts a dividend of the advertisement listing charge received from the advertiser in accordance with the presentation number of the portable telephone user (S42). And its dividend is deducted to the portable telephone user.

A sixth example will be described below. The sixth example concerns a program for reducing the service charge at the portable telephone. The portable telephone 1 as shown in FIG. 1 comprises a service charge reducing program in the resident application 3 and a CPU 4 for executing the process for reducing the service charge in accordance with the program. This service charge reducing program enables the computer (CPU 4) to perform the processes of FIGS. 3 to 6. Also, the resident application 3 is saved in the download application saving area 13 within the portable telephone 1.

The CPU 4 reads the resident application 3 from the download application saving area 13, and executes the process for reducing the service charge in accordance with the program. The contents of the process performed by the CPU 4 have been already described and are not described here.

As described above, with the invention, the service charge reducing method comprises a program transmission step of transmitting a program for reducing the service charge of the portable terminal from the advertising information administration center to the portable terminal in response to a request from the portable terminal, and a service charge reducing step of performing a service charge reducing process for the portable terminal including setting the extracting condition of the advertising information in accordance with the program at the portable terminal, in which the service charge reducing step comprises a step of returning a predetermined answer to an originator of the advertising information distributed to the portable terminal, whereby there are the effects that the portable telephone user can set the extraction condition of the advertising information and the feedback information from the portable telephone is returned.

More specifically, a first effect is that unnecessary information for the portable telephone user is excluded in advance (advertiser does not distribute the information to the user having small advertisement effect). Its reason is that the extraction condition of the advertising information is set on the portable telephone user side.

A second effect is that the portable telephone user can deduct the advertisement listing charge obtained from the advertiser (advertiser surely confirms the distribution number and presentation number of the advertising information and grasps the advertising effect numerically). Its reason is that the resident program of the portable telephone can administer the acquisition number and presentation number of the advertising information and can transmit this information to the advertising information administration center.

A third effect is that the portable telephone user is invited to an information site or a settlement site provided by the advertiser and already established based on the advertising information. Its reason is that the resident program can initiate the site perusal function with the link information that is given to the advertising information.

What is claimed is:

1. A service charge reducing method for a portable terminal to reduce a service charge of the portable terminal, in which said portable terminal and an advertising information administration center are connected via a network and said portable terminal receives a distribution of the predetermined advertising information from said advertising information administration center, said method comprising:
a program transmission step of transmitting a program for reducing the service charge of said portable terminal from said advertising information administration center to said portable terminal in response to a request from said portable terminal; and
a service charge reducing step of performing a service charge reducing process for the portable terminal including setting the extracting condition of the advertising information in accordance with said program at said portable terminal.

2. The service charge reducing method for the portable terminal according to claim 1, wherein said service charge reducing step comprises a step of returning a predetermined answer to an originator of the advertising information distributed to said portable terminal.

3. The service charge reducing method for the portable terminal according to claim 1, wherein said program transmitting step comprises a step of transmitting the information including the user information from said portable terminal to said advertising information administration center, and a step of transmitting a program for reducing the service charge for the portable terminal from said advertising information administration center receiving said information to said portable terminal.

4. The service charge reducing method for the portable terminal according to claim 1, wherein said service charge reducing step comprises a step of setting the extracting condition of said advertising information at said portable terminal, a step of making an inquiry about whether or not there is the new advertising information in accordance with the set extracting condition from said portable terminal to said advertising information administration center, a step of acquiring the advertising information consistent with said extracting condition in said advertising information administration center and distributing said acquired advertising information to said portable terminal, a step of saving the advertising information acquired at said portable terminal in an advertising information database, and a step of adding a record holding the presentation number of the advertising information acquired at said portable terminal to a presentation number database.

5. The service charge reducing method for the portable terminal according to claim 2, wherein said service charge reducing step comprises a step of reading the advertising information from the advertising information database at said portable terminal periodically and displaying the read advertising information on the screen, a step of updating the presentation number for a corresponding record in the presentation number database holding the presentation number of the advertising information, a step of performing a confirming operation for the detailed advertising information or a purchasing operation at said portable terminal when advertisement is displayed, a step of notifying a URL of the advertising information in which advertisement is displayed to a site perusal function, which is initiated by said operation, and a step of gaining access to said URL from said site perusal function.

6. The service charge reducing method for the portable terminal according to claim 1, wherein said service charge reducing step comprises a step of reading the information from the presentation number database holding the presentation number of the advertising information at said portable terminal periodically, a step of transmitting the read presentation number information to said advertising information administration center, and a step of enabling said advertising information administration center receiving said presentation number information to save the information in a presentation number administration database for each user within said advertising information administration center.

7. The service charge reducing method for the portable terminal according to claim 1, wherein said service charge reducing step comprises a step of enabling said advertising information administration center to receive the advertising information and an advertisement listing charge from an advertiser, and register the advertising information in the advertising information database, and a step of enabling said advertising information administration center to totalize the information of the presentation number administration database for each user periodically and accept a dividend of the advertisement listing charge received from the advertiser in accordance with the presentation number for the portable terminal user.

8. A service charge reducing system for a portable terminal to reduce a service charge of the portable terminal, in which said portable terminal and an advertising information administration center are connected via a network, and said portable terminal receives a distribution of the predetermined advertising information from said advertising information administration center, said system comprising:
program transmission means for transmitting a program for reducing the service charge of said portable terminal from said advertising information administration center to said portable terminal in response to a request from said portable terminal; and
service charge reducing means for performing a service charge reducing process of the portable terminal including setting the extracting condition of the advertising information in accordance with said program at said portable terminal.

9. The service charge reducing system for the portable terminal according to claim 8, wherein said service charge reducing means comprises a function of returning a predetermined answer to an originator of the advertising information distributed to said portable terminal.

10. The service charge reducing system for the portable terminal according to claim 8, wherein said program transmitting means comprises a function of transmitting the information including the user information from said portable terminal to said advertising information administration center, and a function of transmitting a program for reducing the service charge of the portable terminal from said advertising information administration center receiving said information to said portable terminal.

11. The service charge reducing system for the portable terminal according to claim 8, wherein said service charge reducing means comprises a function of setting the extracting condition of said advertising information at said portable terminal, a function of making an inquiry about whether or not there is the new advertising information in accordance with the set extracting condition from said portable terminal to said advertising information administration center, a function of acquiring the advertising information consistent with said extracting condition in said advertising information administration center and distributing said acquired advertising information to the portable terminal, a function of saving the advertising information acquired at said portable terminal in an advertising information database, and a function of adding a record holding the presentation number of the advertising information acquired at said portable terminal to a presentation number database.

12. The service charge reducing system for the portable terminal according to claim 9, wherein said service charge reducing means comprises a function of reading the advertising information from an advertising information database at said portable terminal periodically and displaying the read advertising information on the screen, a function of updating the presentation number for a corresponding record in the presentation number database holding the presentation number of the advertising information, a function of performing a confirming operation for the detailed advertising information or a purchasing operation at said portable terminal when advertisement is displayed, a function of notifying a URL of the advertising information in which advertisement is displayed to a site perusal function, which is initiated by said operation, and a function of gaining access to said URL from said site perusal function.

13. The service charge reducing system for the portable terminal according to claim 8, wherein said service charge reducing means comprises a function of reading the information from the presentation number database holding the presentation number of the advertising information at said portable terminal periodically, a function of transmitting the read presentation number information to said advertising information administration center, and a function of enabling said advertising information administration center receiving said presentation number information to save the information in a presentation number administration database for each user within said advertising information administration center.

14. The service charge reducing system for the portable terminal according to claim 8, wherein said service charge reducing means comprises a function of enabling said advertising information administration center to receive the advertising information and an advertisement listing charge from an advertiser, and register the advertising information in the advertising information database, and a step of enabling said advertising information administration center to totalize the information of the presentation number administration database for each user periodically and accept a dividend of the advertisement listing charge received from the advertiser in accordance with the presentation number for the portable terminal user.

15. A recording medium having recorded thereon a program for causing a computer to perform a service charge reducing process for a portable terminal, in which said portable terminal and an advertising information administration center are connected via a network, and said portable terminal receives a distribution of the predetermined advertising information from said advertising information administration center, said program comprising:
a step of performing the service charge reducing process of the portable terminal including setting the extracting condition of the advertising information in accordance with said program at said portable terminal,
in the case of transmitting a program for reducing the service charge of said portable terminal from said advertising information administration center to said portable terminal in response to a request from said portable terminal.

16. The recording medium according to claim 15, wherein said service charge reducing step comprises a step of returning a predetermined answer to an originator of the advertising information distributed to said portable terminal.

17. The recording medium according to claim 15, wherein said step of transmitting said program comprises a step of transmitting the information including the user information from said portable terminal to said advertising information administration center, and a step of transmitting the program for reducing the service charge for the portable terminal from said advertising information administration center receiving said information to said portable terminal.

18. The recording medium according to claim 15, wherein said service charge reducing step comprises a step of setting the extracting condition of said advertising information at said portable terminal, a step of making an inquiry about whether or not there is the new advertising information in accordance with the set extracting condition from said portable terminal to said advertising information administration center, a step of acquiring the advertising information consistent with said extracting condition in said advertising information administration center and distributing said acquired advertising information to the portable terminal, a step of saving the advertising information acquired at said portable terminal in an advertising information database, and a step of adding a record holding the presentation number of the advertising information acquired at said portable terminal to a presentation number database.

19. The recording medium according to claim 16, wherein said service charge reducing step comprises a step of reading the advertising information from the advertising information database at said portable terminal periodically and displaying the read advertising information on the screen, a step of updating the presentation number for a corresponding record in the presentation number database holding the presentation number of the advertising information, a step of performing a confirming operation for the detailed advertising information or a purchasing operation at said portable terminal when advertisement is displayed, a step of notifying a URL of the advertising information in which advertisement is displayed to a site perusal function, which is initiated by said operation, and a step of gaining access to said URL from said site perusal function.

20. The recording medium according to claim 15, wherein said service charge reducing step comprises a step of reading the information from the presentation number database holding the presentation number of the advertising information at said portable terminal periodically, a step of transmitting the read presentation number to said advertising information administration center, and a step of enabling said advertising information administration center receiving said presentation number information to save the information in a presentation number administration database for each user within said advertising information administration center.

21. The recording medium according to claim 15, wherein said service charge reducing step comprises a step of enabling said advertising information administration center to receive the advertising information and an advertisement listing charge from an advertiser, and register the advertising information in the advertising information database, and a step of enabling said advertising information administration center to totalize the information of the presentation number administration database for each user periodically and accept a dividend of the advertisement listing charge received from the advertiser in accordance with the presentation number for the portable terminal user.
